(19) United States
(12) Patent Application Publication
(10) Pub. No.: US 2018/0174126 A1
(43) Pub. Date: Jun. 21, 2018

(54) OBJECT RECOGNITION APPARATUS AND METHOD

(71) Applicant: TOSHIBA TEC KABUSHIKI KAISHA, Tokyo (JP)

(72) Inventor: Hidehiro Naito, Mishima Shizuoka (JP)

(21) Appl. No.: 15/845,084

(22) Filed: Dec. 18, 2017

(30) Foreign Application Priority Data
Dec. 19, 2016 (JP) 2016-245715

(51) Int. Cl. G06Q 20/20; G07G 1/00; G06K 9/46; G07G 1/12

(52) U.S. Cl. CPC G06Q 20/208; G07G 1/0009; G07G 1/12; G06K 9/4652; G07G 1/0054

(57) ABSTRACT

An object recognition apparatus includes an image capturing unit sensitive to light in a first wavelength range and to light in a second wavelength range, and a processing unit programmed to identify an article in an image captured by the image capturing unit using first image data that is generated by the image capturing unit from the light in the first wavelength range received by the image capturing unit and second image data that is generated by the image capturing unit from the light in the second wavelength range received by the image capturing unit.

### CROSS-REFERENCE TO RELATED APPLICATION

This application is based upon and claims the benefit of priority from Japanese Patent Application No. 2016-245715, filed Dec. 19, 2016, the entire contents of which are incorporated herein by reference.

### FIELD

Embodiments described herein relate generally to an object recognition apparatus and method.

### BACKGROUND

In the related art, there is a conventional technique related to object recognition for recognizing the type or identity of an article or the like in accordance with a degree of similarity obtained by comparing feature data of an article extracted from a captured image of the article with previously prepared article reference feature data for correlation therebetween. In the conventional object recognition process, an article included in an image is extracted from a red-green-blue (RGB) image, and feature data of the image of the article is extracted from the image and compared to stored image data to determine the article's identity.

In order to reduce blur in the captured image by a camera, it is necessary to shorten the open time of the shutter of the camera. However, if the time the shutter is open is shortened, the captured image becomes darker. In such a case, it is possible to prevent the captured image from being darkened by irradiating the article with visible light in synch with the exposure timing of a camera.

However, in the image captured by such a method, the background becomes black if there is no reflective article captured by the camera other than the article itself. Thus, if the article itself is black such as an eggplant or an avocado, it is hard to distinguish whether the article is the article or the background, and thus, it is hard to extract the image or image data of the article from the captured image.

### DESCRIPTION OF THE DRAWINGS

FIG. 1 is a perspective view illustrating an example of a checkout system according to a first embodiment.

FIG. 2 is a front view illustrating an example of a commodity reading unit.

FIG. 3 is a sectional view illustrating the example of the commodity reading unit.

FIG. 4 is a block diagram illustrating an example of a hardware configuration of a POS terminal and a commodity reading apparatus.

FIG. 5 is an explanatory diagram illustrating an example of a data configuration of a PLU file.

FIG. 6 is a block diagram illustrating a characteristic functional configuration included in the POS terminal.

FIG. 7 is an explanatory diagram illustrating an example of a data configuration of an image data table.

FIG. 8 is a flowchart illustrating an example of commodity registration processing.

FIG. 9 is a block diagram illustrating a characteristic functional configuration included in a POS terminal according to a second embodiment.

FIG. 10 is a perspective view illustrating an example of a configuration of a self-checkout POS terminal.

FIG. 11 is a block diagram illustrating an example of a hardware configuration of the self-checkout POS terminal.

### DETAILED DESCRIPTION

Embodiments provide an object recognition apparatus and a method of recognizing an object with improved accuracy.

In general, according to one embodiment, an object recognition apparatus includes an image capturing unit sensitive to light in a first wavelength range and to light in a second wavelength range, and a processing unit programmed to identify an article in an image captured by the image capturing unit using first image data that is generated by the image capturing unit from the light in the first wavelength range received by the image capturing unit and second image data that is generated by the image capturing unit from the light in the second wavelength range received by the image capturing unit.

Hereinafter, an information processing apparatus and an information processing method according to an embodiment will be described in detail with reference to the drawings. The embodiments which will be described below are embodiments of the information processing apparatus and the information processing method, and do not limit configurations thereof, specifications thereof, and the like. The present embodiments are examples of application to a checkout system used in a store such as a supermarket.

### First Embodiment

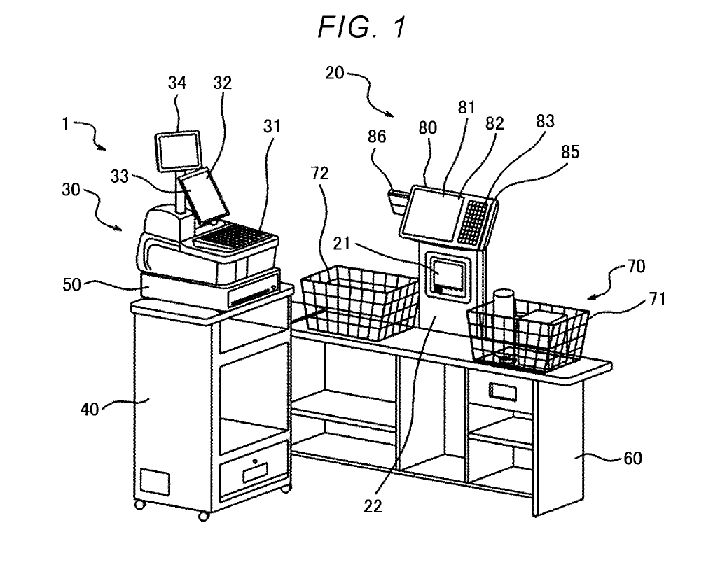

FIG. 1 is a perspective view illustrating an example of a checkout system 1 according to a first embodiment. The checkout system 1 includes a commodity reading apparatus 20 which reads information on commodities and a point of sales (POS) terminal 30 which registers and calculates prices for commodities for a commodity sales transaction. Hereinafter, an example in which an information processing apparatus is applied to the POS terminal 30 will be described. In addition, a case where a target object (also referred to as article) is a commodity will be described as an example of a target article of object recognition, but the target article may not be limited to a commodity.

The POS terminal 30 is placed on an upper surface of a cash drawer 50 housing on a checkout stand 40. The POS terminal 30 controls an opening operation of the drawer 50. The POS terminal 30 includes a first keyboard 31 to which an operator (e.g., store clerk) inputs data. The POS terminal 30 includes a first display unit 32 for displaying various types of information toward the operator on a further back location of the POS terminal 30 than the first keyboard 31 when viewed from the operator. The first display unit 32 includes a touch panel 33 that receives various inputs. The POS terminal 30 includes a second display unit 34 rotatably provided in an erected state on a further back location thereon than the first display unit 32. The second display unit 34 illustrated in FIG. 1 faces a front side in FIG. 1, but displays various types of information for customers by being rotated so as to face a customer side in FIG. 1.

A counter stand 60 is in a shape of a horizontally elongated shelf. The counter stand 60 is disposed so as to form an L shape with the checkout stand 40 on which the cash drawer 50 and POS terminal 30 is located. A shopping basket 70 for containing commodities is placed on the counter stand 60. The shopping basket 70 is not limited to what is called a basket shape but may be a tray or the like. Alternatively, the shopping basket 70 may be box-shaped, bag-shaped, or no basket may be used. The shopping basket 70 includes a first shopping basket 71 brought in by a customer and a second shopping basket 72.

The commodity reading apparatus 20 is located on the counter stand 60, and is connected to the POS terminal 30 so as to transmit data to, and receive data from, each other. The commodity reading apparatus 20 is covered with a thin rectangular housing 22. The housing 22 includes a reading window 21 on a front side thereof. The commodity reading apparatus 20 includes a display operation unit 80 on an upper part of the housing 22.

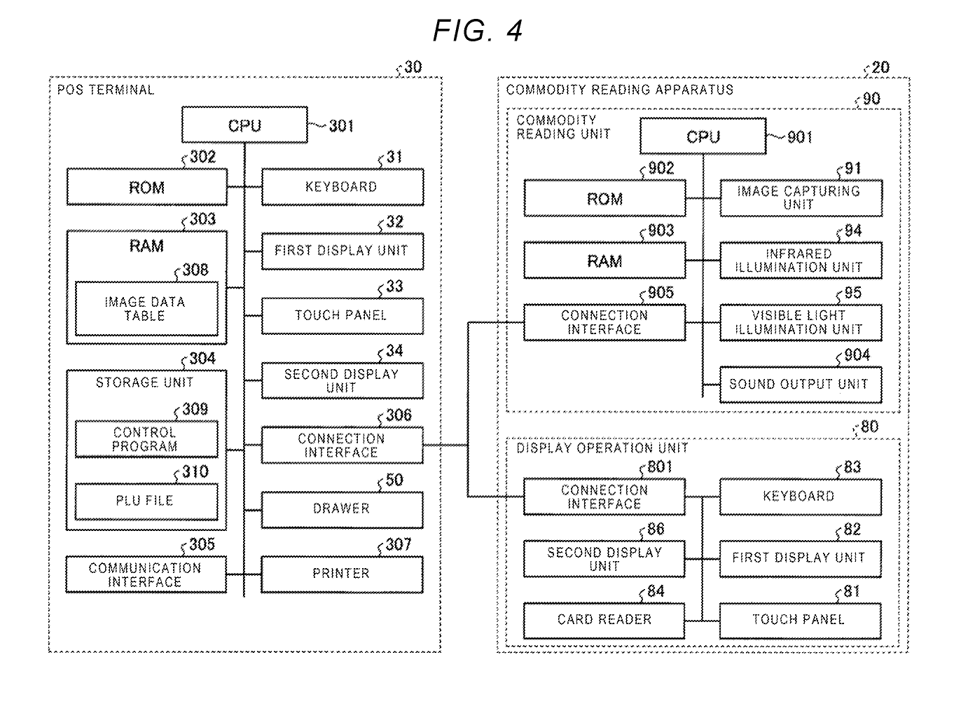

The display operation unit 80 includes a first display unit 82 on which a touch panel 81 is overlaid. The commodity reading apparatus 20 includes a second keyboard 83 on the right side of the first display unit 82. The commodity reading apparatus 20 includes a card reading slot 85 of a card reader 84 (refer to FIG. 4) located on the right side of the second keyboard 83. The commodity reading apparatus 20 includes a second display unit 86 for providing information to customers to the left and the back side of the display operation unit 80 when viewed from the operator.

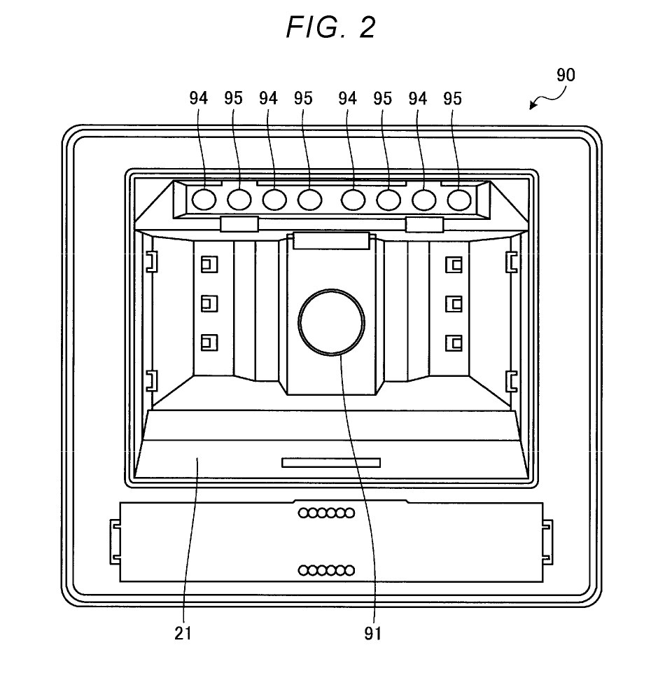

The commodity reading apparatus 20 includes a commodity reading unit 90 (refer to FIG. 2) in the housing 22. The commodity reading unit 90 includes an image capturing unit 91 (refer to FIG. 2) inside the reading window 21.

Commodities are contained in the first shopping basket 71. An operator moves the commodity in the first shopping basket 71 to the second shopping basket 72. During this movement, the operator holds the commodity over the reading window 21. At this time, the image capturing unit 91 (refer to FIG. 2) captures an image of the commodity.

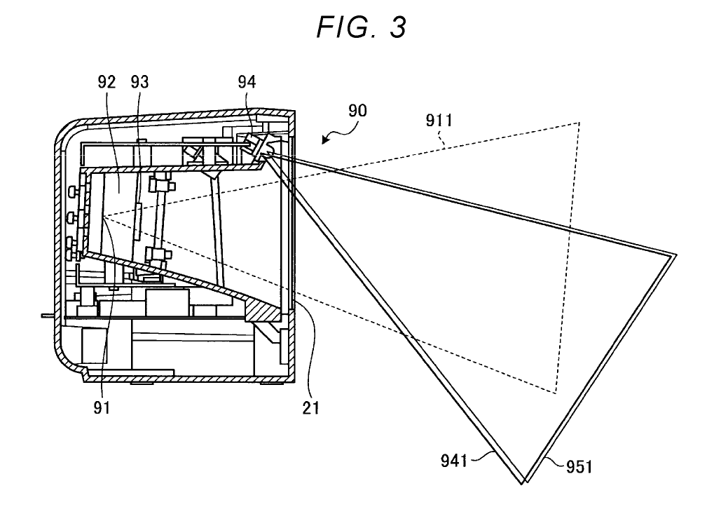

FIG. 2 is a front view illustrating an example of the commodity reading unit 90. FIG. 3 is a sectional view illustrating the example of the commodity reading unit 90. The commodity reading unit 90 includes an image capturing unit 91, an optical filter 92, an imaging lens 93, infrared illumination units 94, and visible light illumination units 95 inside the reading window 21. The infrared illumination units 94 and the visible light illumination units 95 are alternately arranged along an imaginary horizontal line inside an upper side of the reading window 21. The infrared illumination units 94 are an illumination device that outputs infrared radiation, i.e., light invisible to the human eye, such as an infrared light emitting diode (LED). Each infrared illumination units 94 outputs the infrared light to an infrared illumination region 941 illustrated in FIG. 3 with infrared radiation. That is, an infrared illumination units 94 outputs infrared light such that the image capturing region 911 of the image capturing unit 91 overlaps the infrared illumination region 941.

The visible light illumination units 95 are an illumination device that outputs visible light, such as an LED. Each visible light illumination units 95 outputs a visible light illumination region 951 illustrated in FIG. 3 with visible light. That is, the visible light illumination units 95 outputs the visible light such that the image capturing region 911 of the image capturing unit 91 overlaps the visible light illumination region 951. In addition, because the outputs of the infrared illumination units 94 and the visible light illumination units 95 are alternately disposed along the width direction of the illumination device, as illustrated in FIG. 3 the infrared illumination region 941 and the visible light illumination region 951 extend over substantially the same region. Thereby, the infrared illumination units 94 and the visible light illumination units 95 can uniformly illuminate the image capturing region 911 of the image capturing unit 91 with the visible light and the infrared light. Although the commodity reading unit 90 illustrated in FIG. 2 includes four infrared illumination units 94 and four visible light illumination units 95, more or fewer of respective units 94, 95 may be provided depending on the circumstances.

The imaging lens 93 is, for example, a fixed focus lens. The imaging lens 93 forms an article image, of an article in the image capturing region 911, on the image capturing unit 91.

The optical filter 92 is, for example, a band pass filter that blocks transmission of light of a specific wavelength region. The optical filter 92 is disposed between the imaging lens 93 and the image capturing unit 91. For example, the optical filter 92 blocks transmission of light of a wavelength region where respective color components overlap each other. The optical filter 92 transmits light of wavelength regions of red (R), green (G), blue (B), and infrared (IR). Thereby, the optical filter 92 emphasizes contrast of light of different wavelength ranges.

The image capturing unit 91 is an image sensor such as a charge coupled device (CCD) or a complementary metal oxide semiconductor (CMOS). The image capturing unit 91 captures an image of a commodity held over the image capturing region 911, based on the light transmitted by the optical filter 92. The image capturing unit 91 is sensitive to light of a first wavelength range and a second wavelength range. Here, the first wavelength range is, for example, infrared radiation. The second wavelength range is, for example, visible light. That is, the image capturing unit 91 is sensitive to light of the wavelength ranges corresponding to Red (R), Green (G), Blue (B), and Infrared (IR). Thereby, each pixel of the image capturing unit 91 can capture images having R, G, B, and IR components. Image capturing of RGB images and IR images may be performed by independent image capturing units. However, if different image capturing units capture images, it is preferable that each of the image capturing units is located close to each other. As such, by providing the image capturing units at substantially the same position, it is possible to prevent the RGB image and the IR image from being captured as images of different regions of the commodity. In addition, the image capturing unit 91 may be an on-chip color filter in which the optical filter 92 is provided on the surface.

FIG. 4 is a block diagram illustrating an example of a hardware configuration of the POS terminal 30 and the commodity reading apparatus 20. The POS terminal 30 includes a central processing unit (CPU) 301, a read only memory (ROM) 302, a random access memory (RAM) 303, a storage unit 304, a communication interface 305, a first keyboard 31, a first display unit 32, a touch panel 33, a second display unit 34, a connection interface 306, a drawer 50, and a printer 307. The CPU 301, the ROM 302, the RAM 303, the storage unit 304, the communication interface 305, the first keyboard 31, the first display unit 32, the touch panel 33, the second display unit 34, the connection interface 306, the drawer 50, and the printer 307 are connected through a bus.

The CPU 301 collectively controls an operation of the POS terminal 30. The ROM 302 stores various programs and data. The RAM 303 temporarily stores various programs and rewritably stores various data. In addition, the RAM 303 stores an image data table 308 which will be described below. The image data table 308 may be stored in another storage medium such as the storage unit 304 or may be stored in another device such as a store server. The CPU 301, the ROM 302, and the RAM 303 configure a computer that controls the POS terminal 30.

The first keyboard 31 includes various keys for operating the POS terminal 30. For example, the first keyboard 31 includes a close key or the like for ending the commodity registration processing of registering a commodity.

The storage unit 304 is a nonvolatile storage device such as a hard disk drive (HDD) or a solid state drive (SSD). The storage unit 304 stores a control program 309 and a price look up (PLU) file 310. The PLU file 310 may be stored in another storage medium or may be stored in another device such as a store server.

The control program 309 causes an operating system or a function of the POS terminal 30 to be performed. The control program 309 causes characteristic functions according to the present embodiment to be performed or executed.

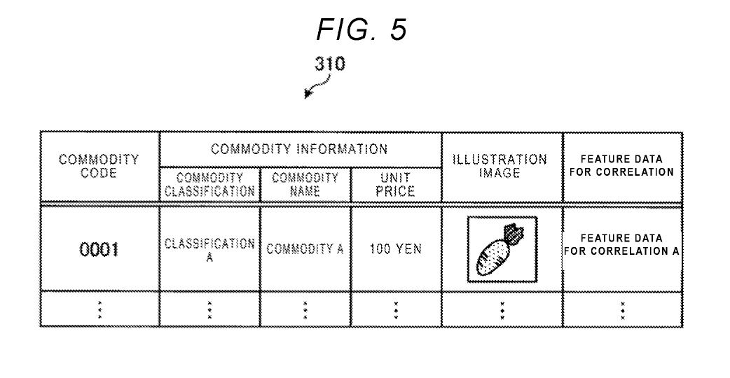

The PLU file 310 is a commodity file that stores information relating to sales registration of commodity for each of various commodities which may be displayed in a store for sale. Here, FIG. 5 is an explanatory diagram illustrating an example of a data configuration of the PLU file 310. The PLU file 310 stores commodity codes, commodity information, illustration images, and reference feature data for correlation in association with each other for each commodity. The commodity code is identification information that can identify a commodity. The commodity information is information such as commodity classification, a commodity name, and a unit price of a commodity. The illustration image shows the commodity. The reference feature data for correlation is obtained by extracting the features of an external appearance of the commodity from the image and parameterizing the features. The features of the appearance of the commodity include a standard shape of the commodity, color of a surface, a pattern, roughness and the like. That is, the reference feature data for correlation has components of R, G, and B based on an RGB image. In addition, the reference feature data for correlation is data used for determination of a degree of similarity of a commodity thereto, which will be described below.

Returning to FIG. 4, the communication interface 305 is connected to the CPU 301. The communication interface 305 communicates with an external device such as a store computer through a network.

The connection interface 306 is connected to the commodity reading apparatus 20. The printer 307 prints receipt papers.

The commodity reading unit 90 includes a CPU 901, a ROM 902, a RAM 903, an image capturing unit 91, infrared illumination units 94, visible light illumination units 95, a sound output unit 904, and a connection interface 905. The CPU 901, the ROM 902, the RAM 903, the image capturing unit 91, the infrared illumination units 94, the visible light illumination units 95, the sound output unit 904, and the connection interface 905 are connected through a bus.

The CPU 901 collectively controls an operation of the commodity reading apparatus 20. The ROM 902 stores various programs and data. The RAM 903 temporarily stores various programs and rewritably stores various data. The CPU 901, the ROM 902, and the RAM 903 configure a computer that controls the commodity reading apparatus 20.

The image capturing unit 91 captures image data at a frame rate, for example, 30 frame per second (fps). The image capturing unit 91 saves the sequentially captured image data in the RAM 903.

The sound output unit 904 is a sound circuit, a speaker, and the like for generating a preset warning sound or the like.

The connection interface 905 connects the POS terminal 30 and the display operation unit 80 to the commodity reading unit 90.

The display operation unit 80 includes a connection interface 801, a second keyboard 83, a first display unit 82, a touch panel 81, a second display unit 86, and a card reader 84. The connection interface 801, the second keyboard 83, the first display unit 82, the touch panel 81, the second display unit 86, and the card reader 84 are connected together over a bus.

The display operation unit 80 is controlled by the CPU 901 or the CPU 301.

The connection interface 801 connects the POS terminal 30 and the commodity reading unit 90 to the display operation unit 80.

The card reader 84 reads information stored in a storage medium of a credit card or the like used for settlement of a commodity purchase transaction. For using the card for settlement, a card reading slot 85 is provided.

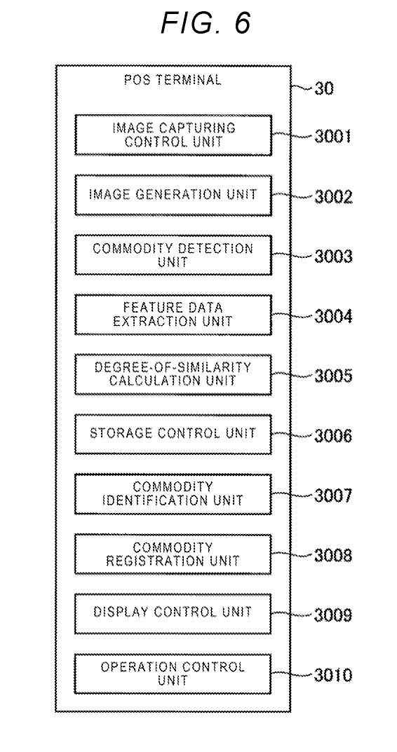

Next, the characteristic functions of the POS terminal 30 will be described. Here, FIG. 6 is a block diagram illustrating a characteristic functional configuration possessed by the POS terminal 30. The control program 309 of the storage unit 304 is loaded into the RAM 303 and the CPU 301 executes the control program 309 to perform the functions of the respective functional units illustrated in FIG. 6 in the RAM 303. These functional units include an image capturing control unit 3001, an image generation unit 3002, a commodity detection unit 3003, a feature data extraction unit 3004, a degree-of-similarity calculation unit 3005, a storage control unit 3006, a commodity identification unit 3007, a commodity registration unit 3008, a display control unit 3009, and an operation control unit 3010.

The image capturing control unit 3001 controls the image capturing operation of the image capturing unit 91. For example, the image capturing control unit 3001 outputs an image capturing request to the commodity reading apparatus 20 and causes the image capturing unit 91 to start an image capturing operation. The image capturing unit 91 stores the sequentially captured image data in the RAM 903. The commodity reading apparatus 20 sequentially outputs image data stored in the RAM 903 to the image capturing control unit 3001. Then, the image capturing control unit 3001 sequentially receives an input of image data.

The image generation unit 3002 generates an RGB image based on visible light and an IR image based on infrared radiation from the image data. For example, the image generation unit 3002 extracts components of R, G, and B included in the image data for each pixel. Then, the image generation unit 3002 generates an RGB image based on the components of R, G, and B which are extracted. In addition, the image generation unit 3002 extracts IR components included in the image data for each pixel. Then, the image generation unit 3002 generates the IR image based on the extracted IR components.

The commodity detection unit 3003 detects commodities included in the IR image. For example, the commodity detection unit 3003 detects all or a part of the commodities included in the IR image by using a pattern matching technique. Specifically, the commodity detection unit 3003 extracts contour lines from an image obtained by binarizing the IR image. The commodity detection unit 3003 detects commodities based on a difference between contour lines extracted from a previously obtained IR image and contour lines extracted from the captured IR image. Here, the previously obtained IR image is an IR image previously obtained by capturing a background in which no commodities are present. Thus, if a commodity is included in the captured IR image, the commodity detection unit 3003 can detect the contour lines of the commodity by taking a difference of the contour lines extracted from the captured IR image and the contour lines extracted from the previously obtained IR image.

Detection of the commodity may not be performed only by using the IR image. For example, the image data captured by the image capturing control unit 3001 may be used directly. That is, the commodity detection unit 3003 may detect a commodity from image data having four image components of R, G, B, and IR.

The feature data extraction unit 3004 identifies a region corresponding to an inner side of a contour line of the commodity in the RGB image. The feature data extraction unit 3004 extracts a feature of a surface of the commodity such as color or roughness as feature data indicating features of a commodity, from the identified region of the RGB image. Thereby, the feature data extraction unit 3004 extracts the feature data of the commodity.

The degree-of-similarity calculation unit 3005 compares reference feature data for correlation in the PLU file 310 with the feature data of the commodity extracted by the feature data extraction unit 3004, thereby, respectively calculating a degree of similarity of each commodity to feature data registered in the PLU file 310. Here, the degree of similarity indicates how similar all or a part of the commodities are, if the reference feature data for correlation stored in the PLU file 310 is set as 100%, then the “degree of similarity=1.0”, and an identical match of detected image features of a commodity to the stored image feature data of a commodity is found. The degree of similarity is typically set to 90 to 95%, to prevent too frequent failure to identify a commodity. The degree-of-similarity calculation unit 3005 may calculate the degree of similarity by changing weighting in, for example, the color and the roughness of a surface.

As such, recognizing an article included in an image is called object recognition. Various object recognition techniques are described in the following documents.

Yanai Keiji, “Present and Future of Generic Object Recognition”, Transaction of Information Processing Society, Vol. 48, No. SIG 16, [Accessed on Dec. 7, 2016], Internet <URL: http://mm.cs.uec.ac.jp/IPSJ-TCVIM-Yanai.pdf>.

In addition, a technique of performing object recognition by dividing an image into regions for each article is described in the following document.

Jamie Shotton et al., “Semantic Texton Forests for Image Categorization and Segmentation”, [Accessed on Dec. 7, 2016], Internet <URL: http://citeseerx.ist.psu.edu/viewdoc/download?doi=10.1.1.145.3036&rep=rep1&type=pdf>.

There is no particular limitation on a method of calculating a degree of similarity between the reference feature data for correlation of various commodities registered in the PLU file 310 and the feature data of a commodity extracted by the feature data extraction unit 3004. For example, the degree-of-similarity calculation unit 3005 may calculate the degree of similarity between the reference feature data for correlation in the PLU file 310 and the feature data of the commodity extracted by the feature data extraction unit 3004 as an absolute evaluation, or may calculate as a relative evaluation.

Extraction may not be performed only by using the RGB image. For example, the image data captured by the image capturing control unit 3001 may be directly used. That is, the feature data extraction unit 3004 may extract the feature data from image data having four components of R, G, B, and IR, that the image capturing unit 91 captures based on light in a wavelength range of visible light and in a wavelength range of infrared light. In this case, the PLU file 310 stores feature data for correlation based on both an RGB image and an IR image. Then, the degree-of-similarity calculation unit 3005 calculates a degree of similarity by comparing the feature data with the feature data for correlation having four components of R, G, B, and IR in the PLU file 310. Alternatively, the feature data extraction unit 3004 may extract the reference feature data for correlation from the IR image. In this case, the PLU file 310 stores the feature data for correlation based on the IR image. Then, the degree-of-similarity calculation unit 3005 calculates a degree of similarity by comparing the feature data with the feature data for correlation having the IR components registered in the PLU file 310.

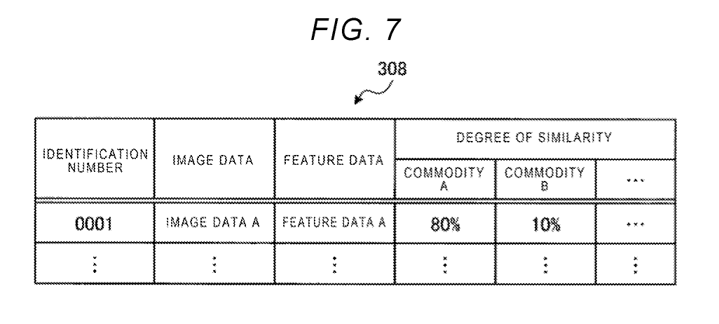

The storage control unit 3006 stores image data in the image data table 308. Here, FIG. 7 is an explanatory diagram illustrating an example of a data configuration of the image data table 308. The image data table 308 stores one or a plurality of identification numbers, one or a plurality of pieces of image data, one or a plurality of pieces of feature data, and one or a plurality of degrees of similarity in association with each other. The identification number is identification information capable of identifying information stored in the image data table 308. The image data is received by the image capturing control unit 3001. The image data may be an RGB image and an IR image. The feature data is extracted by the feature data extraction unit 3004 for commodities included in the associated image data. The degree of similarity of a commodity to those registered in the PLU file 310 is determined by comparing the image data of the detected commodity with that of commodities in the PLU file 310, and the degree-of-similarity calculation unit 3005 determines the percentage of the degree of similarity. Then, the storage control unit 3006 deletes all of the image data stored in the image data table 308 once the commodity information is entered into the registry for the transaction. The storage control unit 3006 may store the image data, the feature data, and the degree of similarity in different data tables, respectively.

Returning to FIG. 6, the commodity identification unit 3007 extracts a commodity corresponding to a commodity included in the image data from the PLU file 310, based on the degree of similarity stored in the image data table 308. Then, the commodity identification unit 3007 identifies the commodity in the image data based on the extraction result. The commodity identification unit 3007 classifies commodities into stages of a confirmed commodity, a commodity candidate, and no extraction and extracts the commodities, according to the degree of similarity stored in the image data table 308. The classification according to the degree of similarity is an example, and may be performed by another method.

Here, the confirmed commodity indicates that a commodity can be registered without a second check by an operator, based on the degree of similarity stored in the image data table 308. The commodity identification unit 3007 determines whether or not a predetermined number or more of degrees of similarity larger than or equal to a first threshold number are registered for each commodity in the image data table 308. The commodity identification unit 3007 extracts a commodity in which a predetermined number or more of degrees of similarity larger than or equal to the first threshold is registered as a confirmed commodity. Then, the commodity identification unit 3007 identifies that the extracted confirmed commodity is a commodity included in an image data.

A commodity candidate indicates that a commodity is a candidate of a commodity whose image is captured by the image capturing unit 91. Then, the commodity candidate is registered for sale as a commodity to be sold by a confirmation operation performed by an operator such as the operator manually selecting a corresponding commodity from one or more commodity candidates. The commodity identification unit 3007 determines whether or not a predetermined number or more of degrees of similarity larger than or equal to a second threshold are registered for each commodity in the image data table 308. The commodity identification unit 3007 extracts a commodity in which a predetermined number or more of the degrees of similarity larger than or equal to the second threshold are registered as the commodity candidate. The second threshold is less than the first threshold. The predetermined number of the degrees of similarity of the commodity candidate may be the same as or different from the predetermined number of the degrees of similarity of a confirmed commodity. Then, the commodity identification unit 3007 identifies that the commodity manually selected from among the commodity candidates is a commodity included in the image data.

Here, no extraction indicates that a commodity corresponding to the commodity included in the image data cannot be extracted from the PLU file 310. The commodity identification unit 3007 identifies that a commodity cannot be identified if a predetermined number or more of a degree of similarity larger than or equal to the second threshold are not registered for each commodity in the image data table 308.

The commodity registration unit 3008 registers for sale the commodity extracted by the commodity identification unit 3007 or the like as a commodity to be sold. That is, the commodity registration unit 3008 registers for sale commodity information of a commodity to be sold. If the commodity identification unit 3007 extracts the confirmed commodity, the commodity registration unit 3008 registers for sale the confirmed commodity as the commodity to be sold. In addition, if the commodity identification unit 3007 extracts a commodity candidate, the commodity registration unit 3008 registers for sale the commodity manually selected from the commodity candidates as a commodity to be sold. Even if the image capturing unit 91 or the like reads a code symbol or the like, the commodity registration unit 3008 registers for sale the commodity specified by the commodity code indicated by the code symbol as the commodity to be sold.

The display control unit 3009 controls all or a part of the first display unit 32, the second display unit 34, the first display unit 82, and the second display unit 86 to display various screens. For example, the display control unit 3009 displays a screen for selecting a commodity to be registered for sale from one or more commodity candidates. In addition, the display control unit 3009 displays a commodity registration screen on which a commodity to be sold that is registered by the commodity registration unit 3008 is displayed.

The operation control unit 3010 controls all or a part of the first keyboard 31, the touch panel 33, the touch panel 81, and the second keyboard 83 to receive various inputs. For example, the operation control unit 3010 receives an operation of selecting a commodity to be registered from one or more commodity candidates.

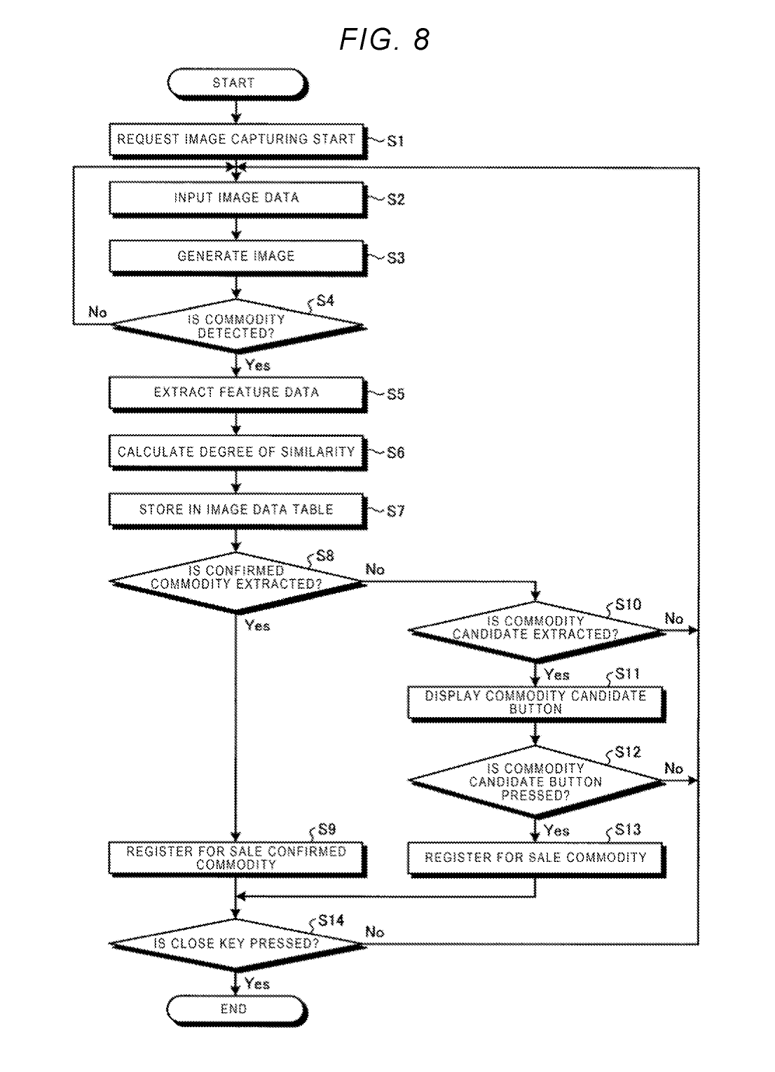

Next, the commodity registration processing performed by the POS terminal 30 will be described. Here, FIG. 8 is a flowchart illustrating an example of the commodity registration processing performed by the POS terminal 30 according to the first embodiment.

The image capturing control unit 3001 requests the commodity reading unit 90 to start image capturing performed by the image capturing unit 91 (S1).

The image capturing control unit 3001 receives an input of image data from the commodity reading unit 90 (S2).

The image generation unit 3002 generates an RGB image and an IR image from the input image data (S3).

The commodity detection unit 3003 determines whether or not a commodity can be detected from the IR image (S4). If the commodity cannot be detected (S4; No), the POS terminal 30 moves to S2.

Meanwhile, if the commodity can be detected (S4; Yes), the feature data extraction unit 3004 extracts feature data of the commodity from the RGB image using the contour data obtained from the IR image (S5). The degree-of-similarity calculation unit 3005 compares feature data extracted by the feature data extraction unit 3004 with the reference feature data for correlation in the PLU file 310 so as to calculate a degree of similarity for each commodity (S6).

The storage control unit 3006 stores the image data, the feature data, and the degree of similarity in the image data table 308 (S7).

The commodity identification unit 3007 determines whether or not the confirmed commodity is extracted, based on the degree of similarity stored in the image data table 308 (S8). If the confirmed commodity is extracted (S8; Yes), the commodity registration unit 3008 registers the confirmed commodity for sale (S9).

If the confirmed commodity is not extracted (S8; No), the commodity identification unit 3007 determines whether or not a commodity candidate is extracted (S10). If the commodity candidate cannot be extracted (S10; No), the POS terminal 30 moves to S2.

Meanwhile, if the commodity candidate can be extracted (S10; Yes), the display control unit 3009 displays a commodity candidate button for registering for sale the extracted commodity candidate on a commodity registration screen (S11).

The operation control unit 3010 determines whether or not pressing of the commodity candidate button is detected (S12). If the pressing of the commodity candidate button is not detected (S12; No), the POS terminal 30 moves to S2.

Meanwhile, if the pressing of the commodity candidate button is detected (S12; Yes), the commodity registration unit 3008 registers for sale the commodity candidate as a commodity to be sold (S13).

Subsequently, the operation control unit 3010 determines whether or not pressing of the close key is detected (S14). If the pressing of the close key is not detected (S14; No), the POS terminal 30 moves to S2.

Meanwhile, if pressing of the close key is detected (S14: Yes), the POS terminal 30 ends the commodity registration processing.

As such, according to the POS terminal 30 of the first embodiment, the image capturing unit 91 is sensitive to a wavelength region of visible light and a wavelength region of infrared light. The commodity detection unit 3003 detects a commodity, based on an IR image generated from the image data. The feature data extraction unit 3004 extracts feature data from an RGB image generated from the image data. Then, the commodity identification unit 3007 confirms the detected commodity, based on a degree of similarity between the feature data extracted by the feature data extraction unit 3004 and the feature data stored in the PLU file 310. In this way, the POS terminal 30 detects the commodity, based on the IR image, and thus, it is possible to detect a commodity regardless of color or the like of the commodity. Thus, the POS terminal 30 can improve accuracy of detecting articles using object recognition.

### Second Embodiment

Next, a second embodiment will be described. Differences between the first embodiment and the second embodiment will be mainly described, and the same names and reference numerals as those in the first embodiment are attached to configuration elements having the same functions as those in the first embodiment, and description thereof will be omitted.

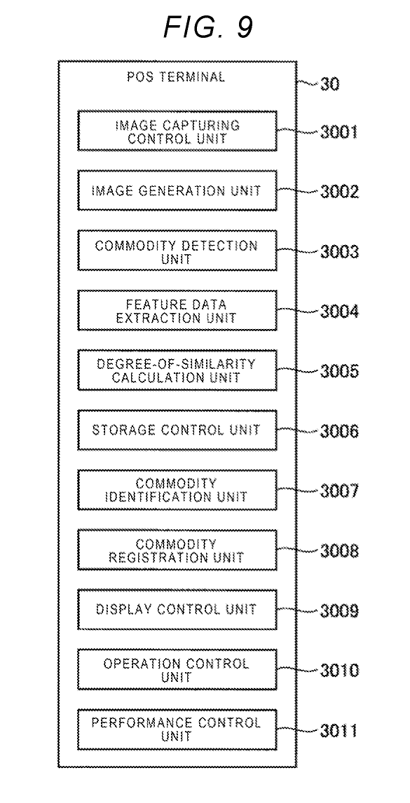

Here, FIG. 9 is a block diagram illustrating a characteristic functional configuration possessed by a POS terminal 30 according to a second embodiment. The POS terminal 30 according to the second embodiment is different from the POS terminal 30 according to the first embodiment in that a performance control unit 3011 is included in the POS terminal 30.

The performance control unit 3011 changes a format of an image to be processed by the commodity detection unit 3003 or the feature data extraction unit 3004, and executes the processing of identifying a commodity again. The processing of identifying the commodity captured by the image capturing unit 91 is, for example, processing from S4 to S13 of the commodity registration processing illustrated in FIG. 8.

For example, in the first processing, the commodity detection unit 3003 detects a commodity from an IR image and the feature data extraction unit 3004 extracts feature data from an RGB image. In the next processing, the performance control unit 3011 sets a target of the commodity detection unit 3003 to the IR image, sets a target of the feature data extraction unit 3004 to image data having components of RGB and IR, and causes execution of the processing of identifying the commodity. Furthermore, in the next processing, the performance control unit 3011 sets the target of the commodity detection unit 3003 to the image data having the components of RGB and IR, sets the target of the feature data extraction unit 3004 to the IR image, and causes execution of the processing of identifying the commodity captured by the image capturing unit 91 again. The performance control unit 3011 arbitrarily set images of any format. Furthermore, the order of combinations of the formats of the images re-performed by the performance control unit 3011 is also arbitrary. In addition, the number of times the performance control unit 3011 executes re-performance is also arbitrary.

In addition, the performance control unit 3011 may have a condition for such re-performance. For example, the condition may be when the commodity identification unit 3007 cannot extract a confirmed commodity or does not extract a commodity candidate. Another condition could be a predetermined time has passed after the commodity detection unit 3003 has detected a commodity.

As described above, according to the POS terminal 30 of the second embodiment, the performance control unit 3011 changes the IR image format, and executes identification of the commodity again. Therefore, even if a commodity cannot be detected from the IR image, the POS terminal 30 tries to detect the commodity from another format, and thus, it is possible to improve accuracy of detecting a commodity. Likewise, the performance control unit 3011 changes the RGB image which then becomes a target from which feature data is extracted, and executes identification of the commodity again. Thus, even if a commodity cannot be identified by using the feature data extracted from the RGB image, the commodity identity is tried to be determined in another format, and thus, the POS terminal 30 can improve accuracy of identifying a commodity.

Furthermore, the performance control unit 3011 only repeats the processing of identifying within a certain time period. Thus, even if processing of identifying a commodity is repeated, the POS terminal 30 can prevent a response time from being lengthened.

While several embodiments are described, the embodiments are provided as examples and are not intended to limit the scope of the exemplary embodiments. The novel embodiments can be implemented in various other forms, and various omissions, substitutions, and changes can be made without departing from the spirit of the exemplary embodiments. The embodiments and modifications thereof are included in the scope and gist of the exemplary embodiments and are included in the claims which will be described below and the equivalent scope thereof.

In addition, in the aforementioned embodiments, the POS terminal 30 is applied as an information processing apparatus having the characteristic functions (the image capturing control unit 3001, the image generation unit 3002, the commodity detection unit 3003, the feature data extraction unit 3004, the degree-of-similarity calculation unit 3005, the storage control unit 3006, the commodity identification unit 3007, the commodity registration unit 3008, the display control unit 3009, the operation control unit 3010, and the performance control unit 3011). However, the exemplary embodiments are not limited to this, and the commodity reading apparatus 20 may be applied as the information processing apparatus having the characteristic functions. Furthermore, the characteristic functions may be distributed in the POS terminal 30 and the commodity reading apparatus 20.

In addition, in the aforementioned embodiments, the exemplary embodiments are applied to the checkout system 1 including the POS terminal 30 and the commodity reading apparatus 20. However, the exemplary embodiments are not limited to this, and may be applied to a single device having the functions of the POS terminal 30 and the commodity reading apparatus 20. An example of the above single device may be a self-checkout POS terminal installed in a store such as a supermarket.

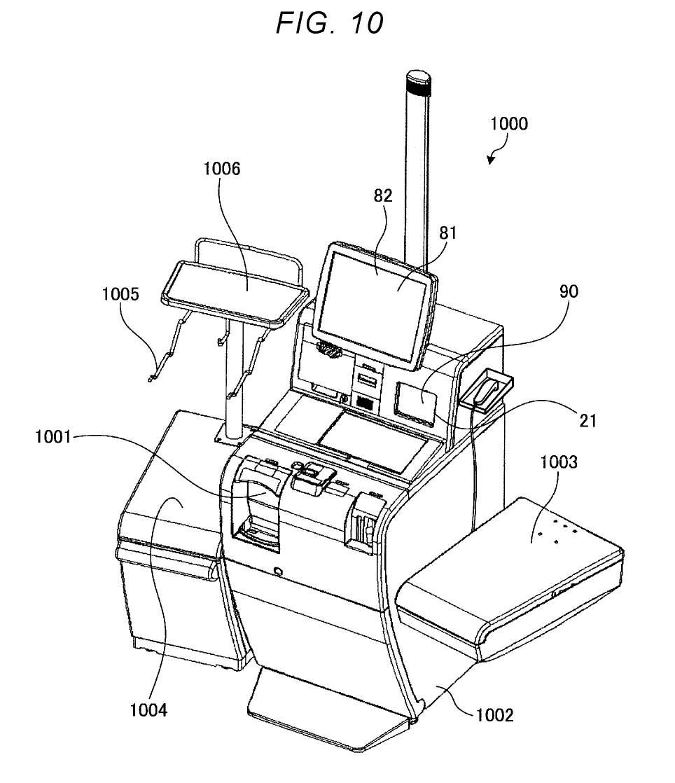

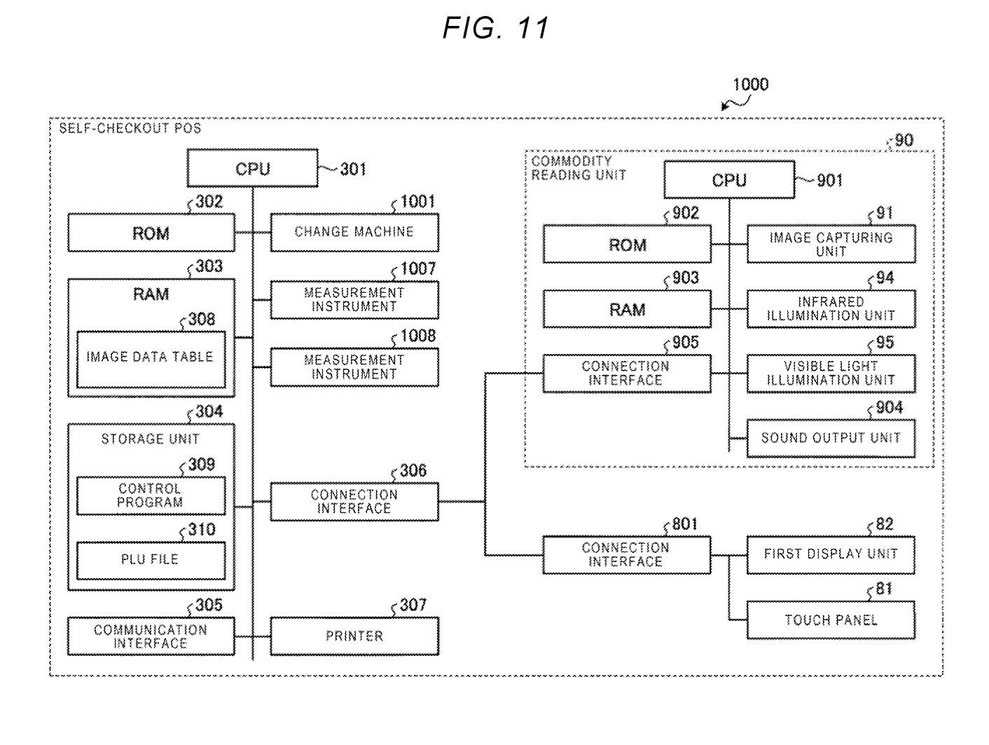

Here, FIG. 10 is a perspective view illustrating an example of a configuration of a self-checkout POS terminal 1000. FIG. 11 is a block diagram illustrating an example of a hardware configuration of the self-checkout POS terminal 1000. Hereinafter, the same symbols or reference numerals are attached to the same configurations as illustrated in FIGS. 1 and 4, and repeated descriptions thereof will be omitted. As illustrated in FIGS. 10 and 11, a main body 1002 of the self-checkout POS terminal 1000 includes a first display unit 82 including a touch panel 81 overlying a surface thereof, and a commodity reading unit 90 which reads a commodity image for recognizing the commodity type.

The first display unit 82 is, for example, a liquid crystal display. The first display unit 82 displays a total amount of money, a deposit amount of money, a change amount of money, and the like of a commodity, and displays a calculation screen or the like for selecting a payment method.

A customer holds up a code symbol attached to a commodity over the reading window 21 of the commodity reading unit 90, and thereby, the commodity reading unit 90 reads the commodity image by using the image capturing unit 91.

In addition, the self-checkout POS terminal 1000 includes a first commodity placing stand 1003 for placing unidentified commodities contained in a basket on the right side of the main body 1002. The self-checkout POS terminal 1000 includes a second commodity placing stand 1004 for placing identified commodities on the left side of the main body 1002. The second commodity placing stand 1004 includes a bag hook 1005 for hanging a bag in which the identified commodities are contained and a temporary placing stand 1006 in which the identified commodities are temporarily placed before the identified commodities are contained in the bag. The commodity placing stands 1003 and 1004 are provided with measurement instruments 1007 and 1008, respectively, and have a function of confirming that weights of commodities are the same before and after identification.

The main body 1002 of the self-checkout POS terminal 1000 includes a change machine 1001 for depositing bills for calculation and for receiving bills for change.

If the self-checkout POS terminal 1000 having such a configuration is applied to the checkout system 1, the self-checkout POS terminal 1000 functions as an information processing apparatus.

A program executed by each device of the embodiment or a modification example is assumed to be incorporated in a storage medium (ROM or storage unit) provided in each device in advance, and the exemplary embodiment is not limited thereto. For example, a configuration may be provided such that the program is recorded in a computer-readable storage medium such as a CD-ROM, a floppy disk (FD), a CD-R, or a digital versatile disk (DVD) as a file of an installable format or an executable format. Furthermore, the storage medium is not limited to a medium independent from the computer or an incorporated system, and also includes a storage medium in which a program transmitted through a LAN, the Internet, or the like is downloaded to be stored or temporarily stored.

In addition, the program executed by each device of the embodiment or the modification example may be stored in a computer connected to a network such as the Internet, and may be configured so as to be provided by being downloaded through the network, or may be configured so as to be provided or distributed through the network such as the Internet.

What is claimed is:

1. An object recognition apparatus comprising:
an image capturing unit sensitive to light in a first wavelength range and to light in a second wavelength range; and
a processing unit programmed to identify an article in an image captured by the image capturing unit using first image data that is generated by the image capturing unit from the light in the first wavelength range received by the image capturing unit and second image data that is generated by the image capturing unit from the light in the second wavelength range received by the image capturing unit.

2. The apparatus according to claim 1, wherein the processing unit is further programmed to extract contours of the article from the first image data and extract feature data of the article from the second image data using the extracted contours.

3. The apparatus according to claim 2, further comprising:
a memory in which reference feature data relating to a plurality of articles are stored,
wherein the processing unit identifies the article by comparing the extracted feature data with the reference feature data.

4. The apparatus according to claim 2, wherein the processing unit extracts contours of the article from the first image data by taking a difference of the first image data and third image data which is generated from an image captured by the image capturing unit without the article being present.

5. The apparatus according to claim 1, wherein the image capturing unit is an image sensor.

6. The apparatus according to claim 1, further comprising:
a first light source for illuminating the article with the light in the first wavelength range; and
a second light source for illuminating the article with the light in the second wavelength range.

7. The apparatus according to claim 6, wherein
the first light source illuminates a first illumination region and the second light source illuminates a second illumination region, both the first and second illumination regions overlapping an image capturing region of the image capturing unit.

8. The apparatus according to claim 6, wherein the first light source is an infrared light source.

9. A point-of-sale (POS) terminal which registers commodities to be purchased, the POS terminal comprising:
an image capturing unit sensitive to light in a first wavelength range and to light in a second wavelength range; and
a processing unit programmed to identify an article in an image captured by the image capturing unit using first image data that is generated by the image capturing unit from the light in the first wavelength range received by the image capturing unit and second image data that is generated by the image capturing unit from the light in the second wavelength range received by the image capturing unit.

10. The POS terminal according to claim 9, wherein the processing unit is further programmed to extract contours of the article from the first image data and extract feature data of the article from the second image data using the extracted contours.

11. The POS terminal according to claim 10, further comprising:
a memory in which reference feature data relating to a plurality of articles are stored,
wherein the processing unit identifies the article by comparing the extracted feature data with the reference feature data.

12. The POS terminal according to claim 10, wherein the processing unit extracts contours of the article from the first image data by taking a difference of the first image data and third image data which is generated from an image captured by the image capturing unit without the article being present.

13. The POS terminal according to claim 9, wherein the image capturing unit is an image sensor.

14. The POS terminal according to claim 9, further comprising:
a first light source for illuminating the article with the light in the first wavelength range; and
a second light source for illuminating the article with the light in the second wavelength range.

15. The POS terminal according to claim 14, wherein the first light source illuminates a first illumination region and the second light source illuminates a second illumination region, both the first and second illumination regions overlapping an image capturing region of the image capturing unit.

16. The POS terminal according to claim 14, wherein the first light source is an infrared light source.

17. A method for identifying an article in an image captured by an image sensor, said method comprising:
generating first image data from light in a first wavelength range received by the image sensor and extracting contours of the article from the first image data;
generating second image data from light in a second wavelength range received by the image sensor and extracting feature data of the article from the second image data using the extracted contours; and
identifying an article in the image using the extracted feature data.

18. The method according to claim 17, wherein the article in the image is identified using the extracted feature data by comparing the extracted feature data with reference feature data for a plurality of articles.

19. The method according to claim 17, wherein the contours of the article are extracted from the first image data by taking a difference of the first image data and third image data which is generated from an image captured by the image capturing unit without the article being present.

20. The method according to claim 17, further comprising:
illuminating the article with the light in the first wavelength range; and
illuminating the article with the light in the second wavelength range,
wherein the first light source is an infrared light source.
